(19) United States
(12) Patent Application Publication
(10) Pub. No.: US 2023/0409924 A1
(43) Pub. Date: Dec. 21, 2023

(54) PROCESSING DEVICE

(71) Applicant: NEC Corporation, Tokyo (JP)

(72) Inventors: Batnyam ENKHTAIVAN, Tokyo (JP); Isamu TERANISHI, Tokyo (JP); Kunihiro ITO, Tokyo (JP)

(73) Assignee: NEC Corporation, Tokyo (JP)

(21) Appl. No.: 18/210,412

(22) Filed: Jun. 15, 2023

(30) Foreign Application Priority Data
Jun. 21, 2022 (JP) 2022-099698

(51) Int. Cl. G06N 5/01; G06N 5/04

(52) U.S. Cl. CPC G06N 5/01; G06N 5/04

(57) ABSTRACT

A processing device includes an acquisition unit and a specifying unit. The acquisition unit acquires, from a decision tree that is a learned model and includes a plurality of nodes, score information representing a value according to the number of pieces of data that fell to each of the nodes, among a plurality of pieces of training data used for training of the decision tree. The specifying unit specifies a possible range that the value of an unknown feature may take, on the basis of the score information acquired by the acquisition unit. The unknown feature is a part of the features included in the training data.

### INCORPORATION BY REFERENCE

The present invention is based upon and claims the benefit of priority from Japanese patent application No. 2022-099698, filed on Jun. 21, 2022, the disclosure of which is incorporated herein in its entirety by reference.

### TECHNICAL FIELD

The present invention relates to a processing device, a processing method, and a storage medium.

### BACKGROUND ART

Art for performing risk assessment on information leakage of a learning model having been learned by using machine learning, such as a risk that learned data is estimated from a learning model, has been known.

For example, Patent literature 1 discloses a system including a processor and a storage device. According to Patent Literature 1, the storage device includes statistical data of learned data of a first learning model, and assessment data for assessing a response of the learning model with the first learning model. Further, the processor generates pseudo data consisting of objective variables and explanatory variables that are the same as those of the learned data on the basis of the statistical data, and performs learning of a second learning model by the pseudo data. Then, the processor compares a response result with respect to the assessment data of the first learning model with a response result with respect to the assessment data of the second learning model, and based on a comparison result, assesses a risk of information leakage from the first learning model.

Further, as related art, Non-Patent Literature 1 is known. Non-Patent Literature 1 describes art used for estimating a value of an unknown feature that is an explanatory variable to be estimated. For example, according to Non-Patent Literature 1, an unknown feature is fixed to any value, a ratio of pieces of training data to be assigned to a subregion that is the same as that of target data, to the pieces of training data of the decision tree, is calculated, and the peripheral probability is assessed by using the calculated ratio as a weight, whereby a probable feature value is estimated.
Patent Literature 1: JP 2022-007311 A
Non-Patent Literature 1: Matthew Fredrikson et al., Model Inversion Attacks that Exploit Confidence Information and Basic Countermeasures, October 2015

### SUMMARY

In the art of Patent Literature 1, in order to perform risk assessment, statistical data of the learned data used for learning the first learning model is required. Therefore, it is impossible to perform assessment when there is no statistical data or the like. Further, in the art described in Non-Patent Literature 1, since probabilistic feature estimation in an average case is performed, appropriate assessment may not be performed depending on the output status or the like of the decision tree. For example, there is a problem that performing processing for appropriate risk assessment may be difficult, as described above.

In view of the above, an object of the present invention is to provide a processing device, a processing method, and a storage medium that solves the above-described problem.

In order to achieve the object, a processing device, according to one aspect of the present disclosure, is configured to include
an acquisition unit that acquires, from a decision tree that is a learned model and includes a plurality of nodes, score information representing a value according to the number of pieces of data that fell to each of the nodes, among a plurality of pieces of training data used for training of the decision tree, and
a specifying unit that, on the basis of the score information acquired by the acquisition unit, specifying a possible range that a value of an unknown feature may take, the unknown feature being a part of a plurality of features included in the training data.

Further, a processing method, according to another aspect of the present disclosure, is configured to include, by an information processing device,
acquiring, from a decision tree that is a learned model and includes a plurality of nodes, score information representing a value according to the number of pieces of data that fell to each of the nodes, among a plurality of pieces of training data used for training of the decision tree, and
on the basis of the acquired score information, specifying a possible range that a value of an unknown feature may take, the unknown feature being a part of a plurality of features included in the training data.

Further, a storage medium, according to another aspect of the present disclosure, is a non-transitory computer readable medium storing thereon a program comprising instructions for causing an information processing device to execute processing to
acquire, from a decision tree that is a learned model and includes a plurality of nodes, score information representing a value according to the number of pieces of data that fell to each of the nodes, among a plurality of pieces of training data used for training of the decision tree, and
on the basis of the acquired score information, specify a possible range that a value of an unknown feature may take, the unknown feature being a part of a plurality of features included in the training data.

With the configurations described above, the problem described above can be solved.

### BRIEF DESCRIPTION OF DRAWINGS

FIG. 1 illustrates an exemplary configuration of a risk assessment system according to a first exemplary embodiment of the present disclosure.

FIG. 2 is a block diagram illustrating an exemplary configuration of a model storage device.

FIG. 3 illustrates an example of a decision tree.

FIG. 4 is a block diagram illustrating an exemplary configuration of a risk assessment device.

FIG. 5 illustrates an example of prior information.

FIG. 6 is a diagram for explaining exemplary operation of a specifying unit.

FIG. 7 is a flowchart illustrating an exemplary operation of a risk assessment device.

FIG. 8 is a flowchart illustrating an example of a detailed operation of step S104.

FIG. 9 illustrates another example of prior information.

FIG. 10 is a block diagram illustrating another exemplary configuration of a risk assessment device.

FIG. 11 illustrates an exemplary configuration of a risk assessment system according to a second exemplary embodiment of the present disclosure.

FIG. 12 is a block diagram illustrating an exemplary configuration of a model storage device.

FIG. 13 is a block diagram illustrating an exemplary configuration of a risk assessment device.

FIG. 14 is a diagram for explaining exemplary processing by a specifying unit.

FIG. 15 is a flowchart illustrating an exemplary operation of a risk assessment device.

FIG. 16 is a block diagram illustrating an exemplary configuration of a processing device according to a third exemplary embodiment of the present disclosure.

FIG. 17 is a block diagram illustrating an exemplary configuration of a processing device.

### EXAMPLE EMBODIMENTS

### First Exemplary Embodiment

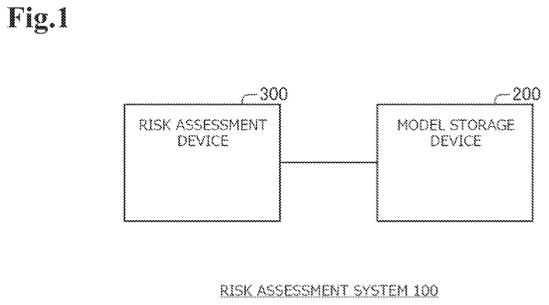

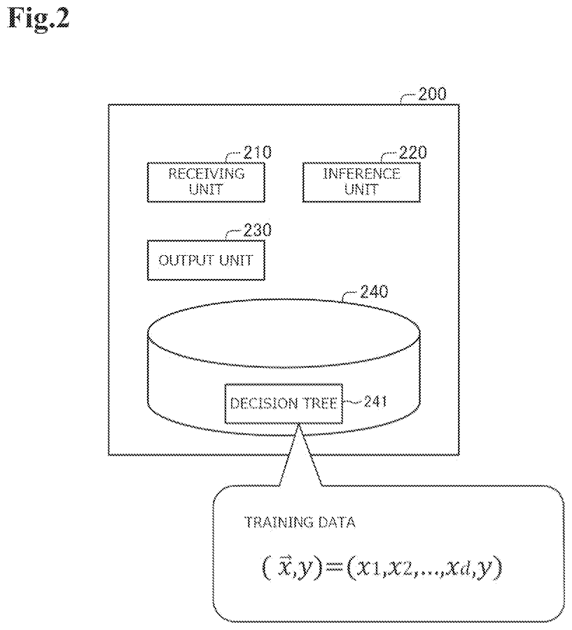

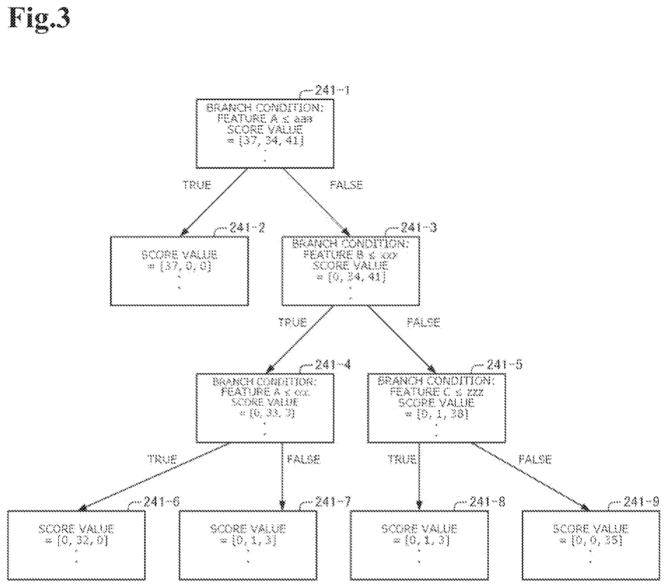

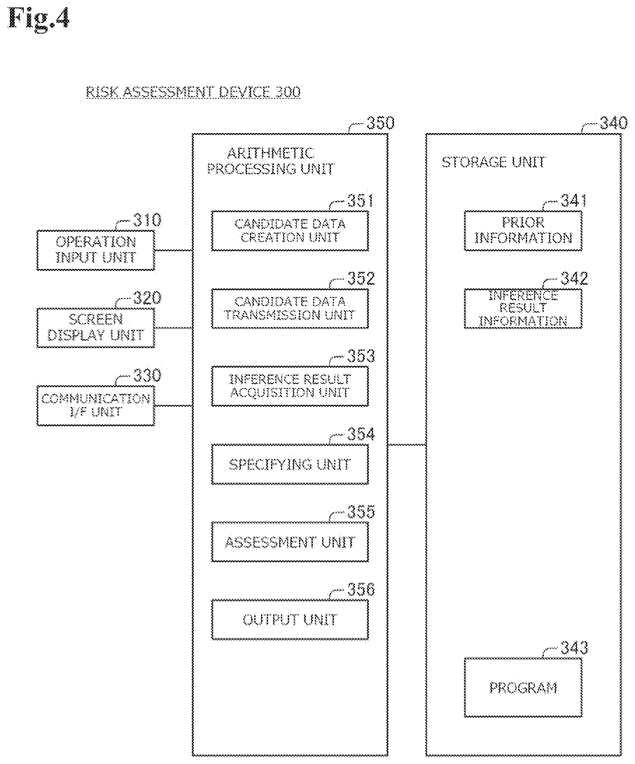

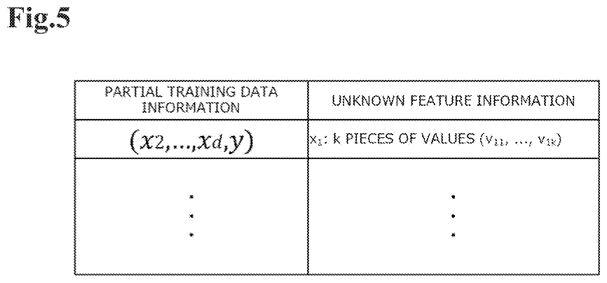

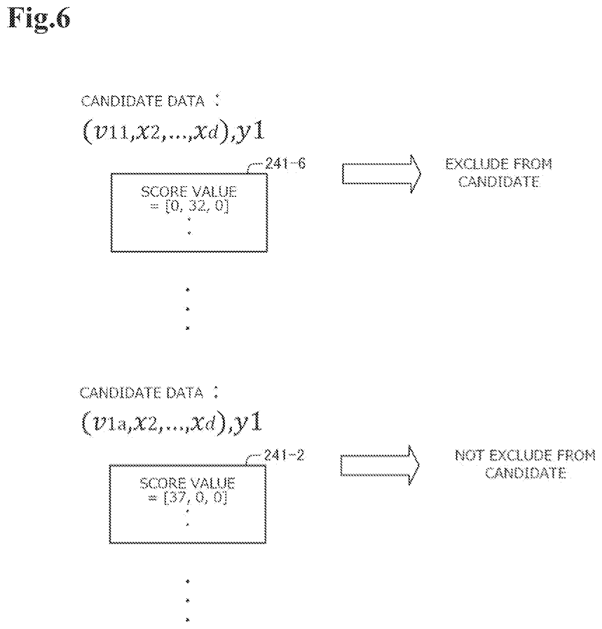

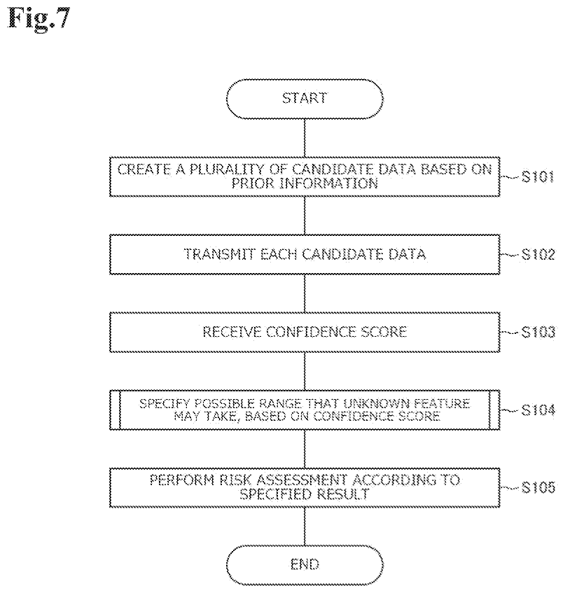

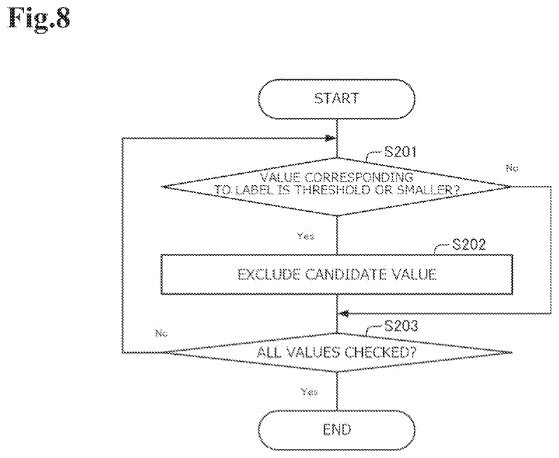

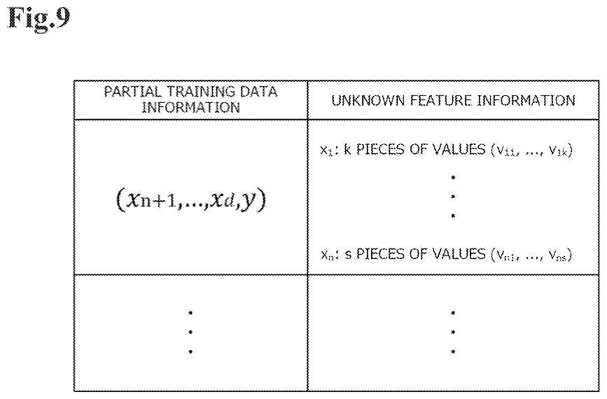

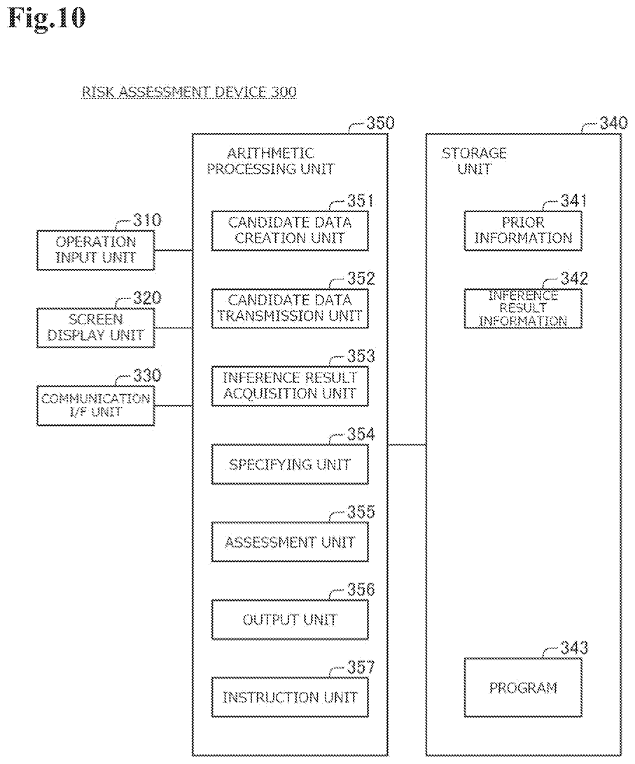

A first exemplary embodiment of the present disclosure will be described with reference to FIGS. 1 to 10. FIG. 1 illustrates an exemplary configuration of a risk assessment system 100. FIG. 2 is a block diagram illustrating an exemplary configuration of a model storage device 200. FIG. 3 illustrates an example of a decision tree. FIG. 4 is a block diagram illustrating an exemplary configuration of a risk assessment device 300. FIG. 5 illustrates an example of prior information 341. FIG. 6 is a diagram for explaining an exemplary operation of a specifying unit 354. FIG. 7 is a flowchart illustrating an exemplary operation of the risk assessment device 300. FIG. 8 is a flowchart illustrating an example of a detailed operation of step S104. FIG. 9 illustrates another example of the prior information 341. FIG. 10 is a block diagram illustrating another exemplary configuration of the risk assessment device 300.

In the first exemplary embodiment of the present disclosure, description will be given on the risk assessment system 100 capable of performing risk assessment by specifying a possible range that a value of an unknown feature may take, when a part of the features constituting training data, having been used for training a decision tree 241 that is a learning model, is unknown. For example, the risk assessment system 100 acquires a confidence score output by the decision tree 241 as score information representing a value corresponding to the data amount of the training data that fell to the node constituting the decision tree 241. Then, the risk assessment system 100 specifies a possible range that the value of an unknown feature may take, based on the acquired confidence score.

For example, in the present embodiment, the risk assessment system 100 knows values (x₂, . . . , x_{d}) of some features among the features (x₁, x₂, . . . , x_{d}) constituting the training data, and knows that the unknown feature x₁ can take any of the k pieces of values (v₁ₗ, . . . , v₁ₖ). In this case, for example, the risk assessment system 100 assumes that the unknown feature x₁ takes any value of (v₁ₗ, . . . , v₁ₖ), and creates candidate data corresponding to each value. Then, the risk assessment system 100 inputs each of the pieces of created candidate data to the decision tree 241 that is a learning model, to thereby acquire a confidence score that is an output from the decision tree 241 corresponding to the input.

The confidence score means, for example, information output by the decision tree 241 in response to an input of candidate data or the like. For example, the confidence score indicates a ratio of the data amount for each label that fell to a leaf node, specified according to the input, to the training data.

FIG. 1 illustrates an exemplary configuration of the risk assessment system 100 in the present embodiment. Referring to FIG. 1, the risk assessment system 100 includes the risk assessment device 300 and the model storage device 200, for example. As illustrated in FIG. 1, the risk assessment device 300 and the model storage device 200 are connected communicably with each other over a network or the like.

The model storage device 200 is an information processing device in which the decision tree 241 that is a learning model having been learned using training data is stored. FIG. 2 illustrates an exemplary configuration of the model storage device 200. For example, referring to FIG. 2, the model storage device 200 includes a storage unit 240 in which the decision tree 241 is stored, and a receiving unit 210, an inference unit 220, and an output unit 230. For example, the model storage device 200 includes an arithmetic unit such as a central processing unit (CPU) and a storage unit. The model storage device 200 implements the respective processing units described above by execution of a program stored in the storage device by the arithmetic unit. Note that the model storage device 200 may includes a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof, instead of the CPU.

As illustrated in FIG. 2, the storage unit 240 stores therein the decision tree 241 having been learned using a plurality of units of training data including a plurality of features and labels. The decision tree 241 may be learned in the model storage device 200 or may be learned outside the model storage device 200. In the present embodiment, a label is a categorical variable that takes a discrete value for example.

FIG. 3 illustrates an example of the decision tree 241. As illustrated in FIG. 3, the decision tree 241 is configured of a plurality of nodes 241-4, 241-2, 241-3, 241-4, 241-5, 241-6, 241-7, 241-8, and 241-9. Among the nodes constituting the decision tree 241, nodes located at terminals such as the nodes 241-2, 241-6, 241-7, 241-8, and 241-9 are referred to as leaf nodes. In the decision tree 241, an input object falls on one leaf node among the leaf nodes, according to a value of the feature of the input data. Of the nodes constituting the decision tree 241, the node 241-1 that is the first node indicating the entire data is referred to as a root node.

For example, as illustrated in FIG. 3, the nodes 241-1, 241-3, 241-4, and 241-5 other than the leaf nodes constituting the decision tree 241 have branch conditions used for classifying input data such as candidate data. For example, as branch information, a condition that a value of a feature is equal to or larger than a given value may be used. The branch condition is adjusted at the time of learning using training data. Each node constituting the decision tree 241 has a score value indicating the ratio of the data amount for each label, allocated to such a node, of the training data. For example, in the example illustrated in FIG. 3, the node 241-4 has a score value of [0, 33, 3]. This indicates that at the time of training of the decision tree 241, the ratio training data having a label 1 allocated to the node 241-4 is 0, the ratio of the training data having a label 2 is 33, and the ratio of the training data having a label 3 is 3. For example, the decision tree 241 can output the score value of a leaf node on which the input data such as candidate data falls, as a confidence score. Note that each node constituting the decision tree 241 may have information other than that illustrated in FIG. 3.

The receiving unit 210 receives candidate data from the risk assessment device 300.

For example, the receiving unit 210 receives candidate data including values of features known to the risk assessment device 300 such as “v₁ₗ, x₂, . . . , x_{d}” and “vₗ₂, x₂, . . . , x_{d}”, and also including candidates for an unknown feature. As an example, the receiving unit 210 receives candidate data of the number corresponding to the number of unknown feature candidates for the risk assessment device 300, from the risk assessment device 300. The receiving unit 210 may receives information other than that illustrated above such as identification information, together with the candidate data.

The inference unit 220 inputs each candidate data received by the receiving unit 210, into the decision tree 241 that is a learning model. As a result of the input, the inference unit 220 acquires a confidence score that is an inference result corresponding to each candidate data. In other words, the inference unit 220 inputs candidate data that is an input to the decision tree 241 to thereby acquire a score value of a leaf node corresponding to the candidate data as a confidence score.

The output unit 230 transmits a confidence score acquired by the inference unit 220 to the risk assessment device 300. For example, the output unit 230 may transmit a confidence score to the risk assessment device 300 together with identification information of the candidate data so as to be able to determine on which candidate data the confidence score is inferred.

For example, the model storage device 200 has the decision tree 241 that is a learning model learned using training data, as described above. When the model storage device 200 receives candidate data from the risk assessment device 300, the model storage device 200 performs inference using the decision tree 241 based on the received candidate data to thereby acquire a confidence score corresponding to the candidate data. Then, the model storage device 200 transmits the acquired confidence score to the risk assessment device 300, as score information.

The risk assessment device 300 is an information processing device that specifies a possible range that an unknown feature may take, based on the confidence score that is score information acquired from the model storage device 200. The risk assessment device 300 can also perform risk assessment of possible privacy leakage, based on the specified result.

FIG. 4 illustrates an exemplary configuration of the risk assessment device 300. Referring to FIG. 4, the risk assessment device 300 includes an operation input unit 310, a screen display unit 320, a communication I/F unit 330, a storage unit 340, and an arithmetic processing unit 350, as main constituent elements.

In FIG. 4, the case of implementing the function of the risk assessment device 300 using one information processing device is illustrated as an example. However, the risk assessment device 300 may be implemented using a plurality of information processing devices such as on the cloud computing, for example. For example, the function as the risk assessment device 300 may be implemented by two information processing devices, that is, a processing device having functions as a candidate data creation unit 351, a candidate data transmission unit 352, an inference result acquisition unit 353, and a specifying unit 354, and an assessment device having functions as an assessment unit 355 and an output unit 356. The risk assessment device 300 may not include part of the above-mentioned constituent elements such as not including an operation unit or an image display unit, or may include constituent elements other than those described above.

The operation input unit 310 is configured of operation input devices such as a keyboard and a mouse. The operation input unit 310 detects operation by a user who operates the risk assessment device 300, and outputs it to the arithmetic processing unit 350.

The screen display unit 320 is a screen display device such as a liquid crystal display (LCD). The screen display unit 320 can display, on the screen, various types of information stored in the storage unit 340, in response to an instruction from the arithmetic processing unit 350.

The communication IN unit 330 is configured of a data communication circuit. The communication IN unit 330 performs data communication with an external device such as the model storage device 200 connected over a communication network.

The storage unit 340 is a storage device such as a hard disk or a memory. The storage unit 340 stores therein processing information and a program 343 required for various types of processing performed in the arithmetic processing unit 350. The program 343 is read and executed by the arithmetic processing unit 350 to thereby implement various processing units. The program 343 is read in advance from an external device or a storage medium via a data input/output function of the communication I/F unit 330 and the like, and is stored in the storage unit 340. The main information stored in the storage unit 340 includes prior information 341, inference result information 342, and the like.

The prior information 341 includes information that is previously known about the training data having been used for training of the decision tree 241 stored in the model storage device 200. For example, the prior information 341 is acquired in advance by using a method of acquiring it from an external device via the communication I/F unit 330 or inputting it using the operation input unit 310, and is stored in the storage unit 340.

FIG. 5 illustrates an example of the prior information 341. Referring to FIG. 5, the prior information 341 includes partial training data information and unknown feature information. For example, as illustrated in FIG. 5, the prior information 341 may include a plurality of pieces of information in which partial training data information and unknown feature information are associated with each other.

Here, partial training data information indicates a set of a feature taking known value and its label in condition when a value of another feature is unknown among training data used for learning of the decision tree 241. For example, FIG. 5 illustrates the case where features (x₂, . . . , x_{d}) and a label y are known, and a feature x₁ is unknown. The unknown feature information indicates information about a value of an unknown feature. For example, FIG. 5 illustrates that the unknown feature x₁ takes any of k pieces of values (v₁ₗ, . . . , v₁ₖ).

The inference result information 342 includes information indicating a confidence score that is score information acquired from the model storage device 200. For example, the inference result information 342 may include information indicating a confidence score corresponding to the number of candidates for the unknown feature. For example, the inference result information 342 is generated and updated, as an inference result acquisition unit 353, to be described below, acquires a confidence score from the model storage device 200.

The arithmetic processing unit 350 includes an arithmetic unit such as a CPU and its peripheral circuits. The arithmetic processing unit 350 reads, from the storage unit 340, and executes the program 343 to implement various processing units through cooperation between the hardware and the program 343. Main processing units to be implemented by the arithmetic processing unit 350 include, for example, a candidate data creation unit 351, a candidate data transmission unit 352, an inference result acquisition unit 353, a specifying unit 354, an assessment unit 355, and an output unit 356. Note that the arithmetic processing unit 350 may include a GPU or the like in place of the CPU, as described above.

The candidate data creation unit 351 creates candidate data based on the prior information 341. For example, the candidate data creation unit 351 creates candidate data corresponding to the number of candidates indicated by the unknown feature information. The candidate data creation unit 351 may create candidate data at any timing.

Specifically, for example, it is assumed that as the prior information 341, partial training data information (x₂, . . . , x_{d}, y) is stored, and as unknown feature information, it is stored that the value of the unknown feature x₁ is any of (v₁ₗ, . . . , v₁ₖ). In this case, assuming that the unknown feature x₁ takes any value of (v₁ₗ, . . . , v₁ₖ), the candidate data creation unit 351 creates candidate data corresponding to each of (v₁ₗ, . . . , v₁ₖ). That is, the candidate data creation unit 351 creates candidate data (v₁ₗ, x₂, . . . x_{d}), . . . , (v₁ₖ, x₂, . . . , x_{d}).

The candidate data transmission unit 352 transmits the candidate data created by the candidate data creation unit 351, to the model storage device 200. The candidate data transmission unit 352 may transmit identification information of the candidate data corresponding to the partial training data information used for creating the candidate data and the like, together with the candidate data.

The inference result acquisition unit 353 receives and acquires a confidence score as a result of inference based on the candidate data, from the model storage device 200. For example, the inference result acquisition unit 353 may acquire a confidence score from the model storage device 200 together with identification information and the like so as to allow the candidate data, that is an inference object, to be distinguishable. Further, the inference result acquisition unit 353 stores the received confidence score in the storage unit 340 as the inference result information 342. The inference result acquisition unit 353 may store the confidence score in the storage unit 340 together with the identification information of the corresponding candidate data or the like.

The specifying unit 354 specifies a possible range that the unknown feature may take, based on the confidence score that is score information. For example, the specifying unit 354 specifies a possible range that the unknown feature may take by excluding, among the candidates (v₁ₗ, . . . , v₁ₖ) of the unknown feature x₁, a candidate for a value determined that it has no possibility of constituting the training data actually or the possibility is low, based on the confidence score.

For example, the specifying unit 354 confirms a value corresponding to the label of the candidate data, in the confidence score. Then, when the value corresponding to the label of the candidate data is a given threshold or smaller, the specifying unit 354 excludes the value of the candidate corresponding to the candidate data from candidates for the unknown feature.

For example, as illustrated in FIG. 6, it is assumed that the label of candidate data (v₁ₗ, x₂, . . . , x_{d}) is y₁. It is also assumed that the confidence score corresponding to the candidate data is [0, 32, 0] and the value corresponding to the label y₁ is 0. In this case, according to the confidence score, it is determined that the number of pieces of training data having a label 1 that fell to the corresponding leaf node, at the time of training of the decision tree 241, is 0. Therefore, on the basis of the confidence score, the specifying unit 354 determines that there is no possibility that the candidate data actually constitutes the training data, and excludes the value of the candidate for the unknown feature included in the candidate data from the candidates.

Further, for example, as illustrated in FIG. 6, it is assumed that the label of candidate data (v₁ₐ, x₂, . . . , x_{d}) is y₁. It is also assumed that the confidence score corresponding to the candidate data is [37, 0, 0] and the value corresponding to the label y₁ is 37. In this case, according to the confidence score, it is determined that the number of pieces of training data having a label 1 that fell to the corresponding leaf node at the time of training of the decision tree 241 is 37. Therefore, on the basis of the confidence score, the specifying unit 354 determines that there is a possibility that the candidate data actually constitutes the training data, and does not exclude the value of the candidate for the unknown feature included in the candidate data from the candidates.

As described above, the specifying unit 354 refers to the confidence score and checks whether or not the value corresponding to the label of the candidate data is equal to or smaller than the threshold, and determines whether or not to exclude the value of the candidate corresponding to the candidate data from the candidates, for example. For example, the specifying unit 354 can specify a possible range that the unknown feature may take, based on the confidence score by performing the above-described determination for each piece of candidate data. Note that the threshold may be set arbitrarily. For example, when the threshold is set to the candidate data is excluded from the candidates only when the candidate data does not constitute the training data absolutely.

The assessment unit 355 can perform risk assessment of privacy leakage or the like, based on the result specified by the specifying unit 354. For example, the assessment unit 355 can perform risk assessment corresponding to the number or ratio of the values of candidates excluded by the specifying unit 354. As an example, the assessment unit 355 can assess that the privacy leakage risk is high as the number or ratio of values of candidates excluded by the specifying unit 354 is large. As a result of excluding values of candidates by the specifying unit 354, there is a case where a value that may be taken by the unknown feature is specified to one value. In that case, on the basis of the result specified by the specifying unit 354, the assessment unit 355 may determine that the risk of privacy leakage is extremely high. The assessment unit 355 may perform the above-described assessment when, as a result of excluding the values that may be candidates from the candidates by the specifying unit 354, a possible range that the value of the unknown feature may take becomes a given range or less.

The output unit 356 outputs information according to a result specified by the specifying unit 354, information representing the assessment result by the assessment unit 355, and the like. For example, the output unit 356 displays such information on the screen display unit 320, or transmits it to an external device via the communication OF unit 330.

The exemplary configuration of the risk assessment device 300 is as described above. Next, an exemplary operation of the risk assessment device 300 will be described with reference to FIGS. 7 and 8.

First, an exemplary operation of the risk assessment device 300 as a whole will be described with reference to FIG. 7. Referring to FIG. 7, the candidate data creation unit 351 creates candidate data based on the prior information 341 (step S101). For example, the candidate data creation unit 351 creates candidate data according to the number of candidates indicated by the unknown feature information.

The candidate data transmission unit 352 transmits each piece of candidate data created by the candidate data creation unit 351, to the model storage device 200 (step S102).

The inference result acquisition unit 353 acquires a confidence score for each piece of candidate data, as a result of inference based on the candidate data, from the model storage device 200 (step S103).

The specifying unit 354 specifies a possible range that the unknown feature may take, based on the confidence score (step S104). For example, the specifying unit 354 specifies a possible range that the unknown feature may take by excluding, among the candidates for the unknown feature x₁, a candidate value determined that it has no possibility of constituting the training data actually or the possibility is low, based on the confidence score.

The assessment unit 355 assesses a risk such as privacy leakage, based on the result specified by the specifying unit 354 (step S105). For example, the assessment unit 355 performs risk assessment corresponding to the number of the pieces of candidate data excluded by the specifying unit 354. As an example, the assessment unit 355 can assess that a risk of privacy leakage is higher as the number of the pieces of candidate data excluded by the specifying unit 354 is larger.

The exemplary configuration of the risk assessment device 300 as a whole is as described above. Next, the processing of step S104 will be described in detail with reference to FIG. 8. Referring to FIG. 8, the specifying unit 354 checks the value corresponding to the label of the candidate data, in the confidence score (step S201).

When the value corresponding to the label of the candidate data in the confidence score is equal to or smaller than a threshold (step S201, Yes), the specifying unit 354 excludes the value of the candidate for the unknown feature included in the candidate data from the candidates (step S202). On the contrary, when the value corresponding to the label of the candidate data in the confidence score exceeds the threshold (step S201, No), the specifying unit 354 does not exclude the candidate data.

When the specifying unit 354 has not checked all pieces of candidate data (step S203, No), the specifying unit 354 checks the confidence score of the unchecked candidate data (step S201). On the contrary, when the specifying unit 354 has checked all pieces of candidate data (step S203, Yes), the specifying unit 354 ends the processing of step S104).

The detailed description of step S104 is as described above.

As described above, the risk assessment device 300 includes the inference result acquisition unit 353 and the specifying unit 354. With such a configuration, the specifying unit 354 can specify the possible range that the unknown feature may take, by excluding the values of candidates satisfying the condition on the basis of the confidence score acquired by the inference result acquisition unit 353. As a result, it is possible to determine the risk according to a specific result. That is, according to the above-described configuration, it is possible to perform risk assessment appropriately even in a situation where the value of the unknown feature can be specified, for example.

In the present embodiment, the case where there is one unknown feature x₁ has been described as an example. However, the present disclosure is applicable without any problems even in the case where there are a plurality of unknown features.

For example, FIG. 9 illustrates an example of the prior information 341 in the case where there are a plurality of unknown features x₁ to xₙ. For example, FIG. 9 illustrates the case where features (xₙ₊₁, . . . , x_{d}) and a label y are known, and values of the features (x₁, . . . , xₙ) are unknown. In this case, the unknown feature information indicates information about the value of each of the unknown features.

When there are a plurality of unknown features as illustrated in FIG. 9, the candidate data creation unit 351 can create pieces of candidate data of the number corresponding to the combinations of candidates for the unknown features, based on the assumption that each unknown feature takes any of the candidates. After the candidate data transmission unit 352, processing can be performed as similar to the case where there is one unknown feature. For example, even in the case where there are a plurality of unknown features as described above, processing that is similar to the case where there is only one unknown feature can be performed except that the number of pieces of candidate data created by the candidate data creation unit 351 is increased.

Furthermore, the model storage device 200 and the risk assessment device 300 may have configurations other than those illustrated as examples in the present embodiment. For example, FIG. 10 illustrates another exemplary configuration of the risk assessment device 300. Referring to FIG. 10, the arithmetic processing unit 350 of the risk assessment device 300 reads and executes the program 343 to thereby have an instruction unit 357, in addition to the constituent elements illustrated in FIG. 4.

The instruction unit 357 gives a predetermined instruction to the model storage device 200 based on a result specified by the specifying unit 354 or an assessment result by the assessment unit 355. For example, the instruction unit 357 can give an instruction about how to output a confidence score that is score information, when a result specified by the specifying unit 354 or an assessment result by the assessment unit 355 satisfies a predetermined condition.

For example, the instruction unit 357 can give an instruction to output only a value of a label having the maximum value as a confidence score, when a result specified by the specifying unit 354 or the like satisfies a predetermined condition. As an example, it is assumed that there is a confidence score [0, 32, 0]. In this case, the instruction unit 357 can give an instruction to the model storage device 200 to output information only indicating that the value of the label 2 is 32 as a confidence score. Moreover, when there is a value that is 0 or equal to or smaller than a given threshold in the confidence score, the instruction unit 357 may give an instruction to the model storage device 200 to output the value while changing it to a value larger than 0 or the threshold. As an example, it is assumed that there is a confidence score [0, 32, 0]. In this case, the instruction unit 357 can give an instruction to the model storage device 200 to output a confidence score having values [3, 32, 4], for example. Note that the changed values may be determined by the model storage device 200 or the risk assessment device 300 by any means. For example, the instruction unit 357 can give an instruction to the model storage device 200 to output a confidence score so as to reduce the possibility of specifying the possible range that the unknown features may take from the confidence score, as described above.

Note that a condition instructed by the instruction unit 357 to the model storage device 200 may be set arbitrarily. For example, the instruction unit 357 can give an instruction as described above when the number or ratio excluded by the specifying unit 354 exceeds a given threshold or when the assessment unit 355 assesses that the risk is high. The instruction unit 357 may give an instruction under a condition other than that illustrated above.

In the present embodiment, the case where the risk assessment system 100 includes the model storage device 200 and the risk assessment device 300 has been describe as an example. However, the risk assessment system 100 may be configured of one information processing device having the functions of the model storage device 200 and the risk assessment device 300 described in the present embodiment. The risk assessment system 100 may adopt other well-known modifications.

### Second Exemplary Embodiment

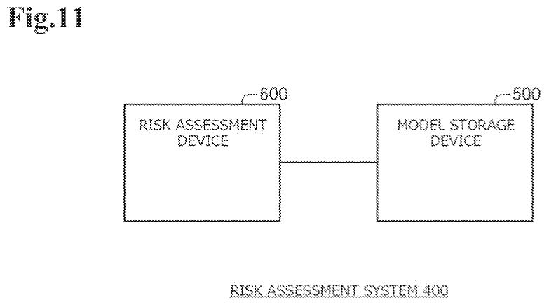

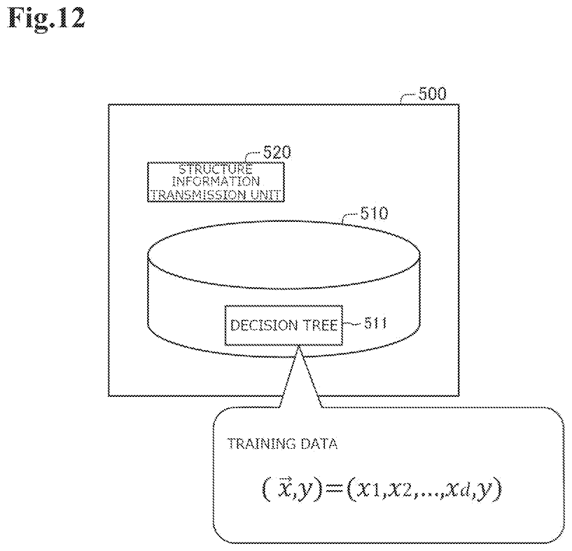

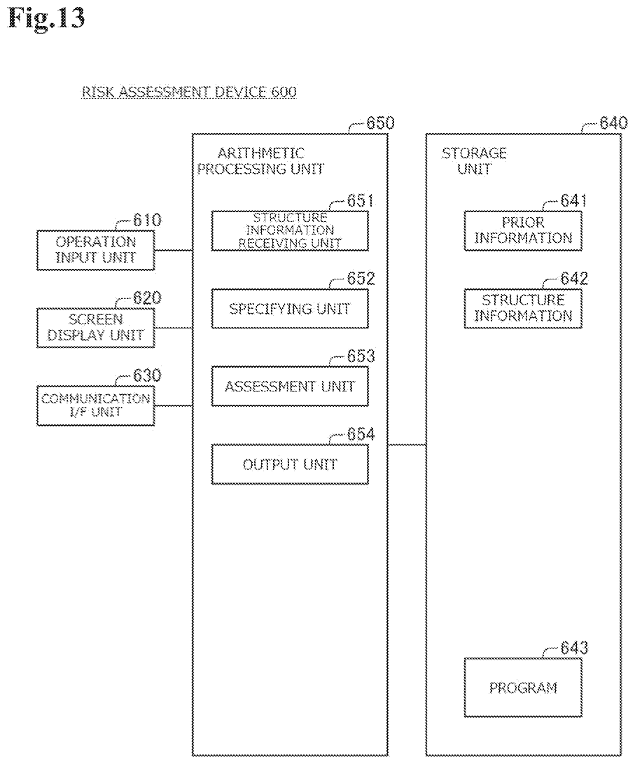

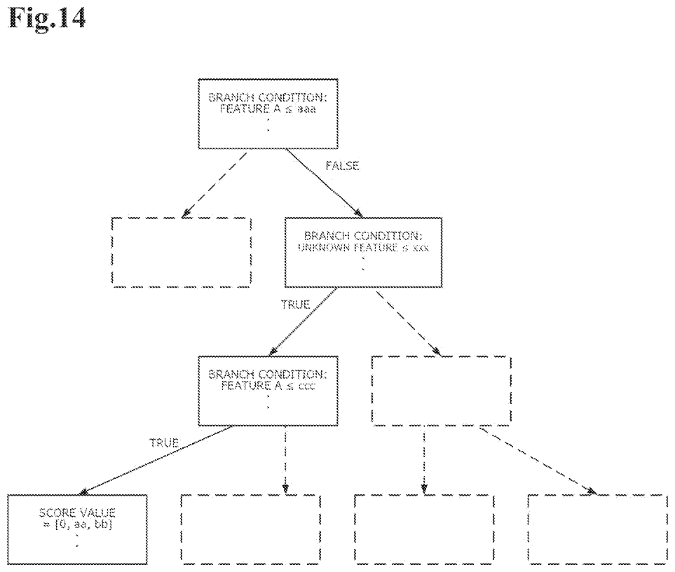

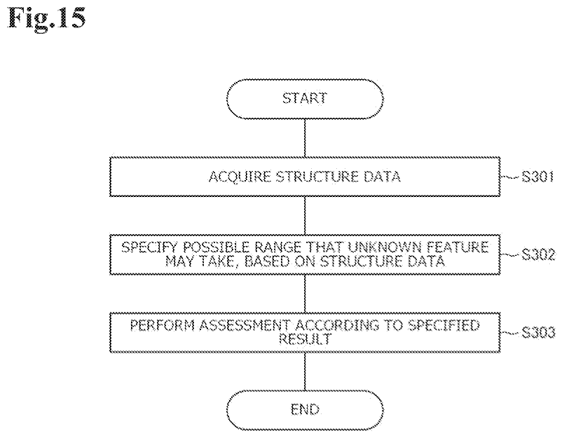

Next, a second exemplary embodiment of the present disclosure will be described with reference to FIGS. 11 to 15. FIG. 11 illustrates an exemplary configuration of a risk assessment system 400. FIG. 12 is a block diagram illustrating an exemplary configuration of a model storage device 500. FIG. 13 is a block diagram illustrating an exemplary configuration of a risk assessment device 600. FIG. 14 is a diagram for explaining exemplary processing performed by a specifying unit 652. FIG. 15 is a flowchart illustrating an exemplary operation of the risk assessment device 600.

The second exemplary embodiment of the present disclosure describes the risk assessment system 400 capable of performing risk assessment by specifying a possible range that a value of an unknown feature may take, in the case where the setting of the decision tree 511 that is a learning model is while box setting. For example, the setting of a model generated by machine learning may be white box setting in which model structure data such as a mode structure and branch conditions are also disclosed, besides black box setting in which only an output corresponding to an input is disclosed to the user as illustrated in the first exemplary embodiment. As described below, the risk assessment system 400 of the present embodiment acquires structure data of the decision tree 511 that is information disclosed due to the white box setting, and specifies a possible range that the value of an unknown feature may take. In other words, in the risk assessment system 400 described in the present embodiment, structure data of the decision tree 511 is acquired as score information instead of a confidence score. Then, the risk assessment system 400 specifies a possible range that the value of an unknown feature may take, based on the acquired structure data.

FIG. 11 illustrates an exemplary configuration of the risk assessment system 400 in the present embodiment. Referring to FIG. 11, the risk assessment system 400 includes the risk assessment device 600 and the model storage device 500, for example. As illustrated in FIG. 11, the risk assessment device 600 and the model storage device 500 are connected communicably with each other over a network or the like, for example.

The model storage device 500 is an information processing device in which the decision tree 511 that is a learning model having been learned using training data is stored. FIG. 12 illustrates an exemplary configuration of the model storage device 500. For example, referring to FIG. 12, the model storage device 500 includes a storage unit 510 in which the decision tree 511 is stored, and a structure information transmission unit 520. For example, the model storage device 500 includes an arithmetic unit such as a CPU and a storage device, and can implement the respective processing units described above through execution of a program stored in the storage device by the arithmetic unit. Note that the model storage device 500 may include a GPU or the like in place of the CPU.

In the storage unit 510, the decision tree 511 that is a learning model having been learned is stored. As described above, the present embodiment adopts white box setting so as to allow the structure of the decision tree 511, branch conditions, and the like to be transmitted to an external device. White box setting is adopted in the case of performing federated learning to conduct model training while exchanging information between clients.

The structure information transmission unit 520 transmits information about the decision tree 511 that is a learning model to the risk assessment device 600, in response to an instruction from the risk assessment device 600 or the like. For example, the structure information transmission unit 520 transmits, to the risk assessment device 600, structure data such as a model structure of the decision tree 511, a branch condition indicating that a feature value is larger or smaller than a threshold or the like, a score value indicating the number of pieces of training data for each label assigned to each node, and the like, as information showing the structure of the decision tree 511. The structure information transmission unit 520 may transmit information about the decision tree 511 other than those described above, to the risk assessment device 600.

Note that the constituent elements held by the model storage device 500 are not limited to those illustrated in FIG. 12. For example, the model storage device 500 may have the configuration of the model storage device 200 described with reference to FIG. 2 in the first exemplary embodiment, in addition to the configuration illustrated in FIG. 12. The model storage device 500 may have a configuration other than that described above.

The risk assessment device 600 is an information processing device that specifies a possible range that an unknown feature may take, by using the structure data acquired from the model storage device 500 as score information. The risk assessment device 600 can also perform risk assessment of privacy leakage, based on the specified result.

FIG. 13 illustrates an exemplary configuration of the risk assessment device 600. Referring to FIG. 13, the risk assessment device 600 includes an operation input unit 610, a screen display unit 620, a communication IN unit 630, a storage unit 640, and an arithmetic processing unit 650, for example, as main constituent elements.

The operation input unit 610, the screen display unit 620, and the communication I/F unit 630 may have the same configurations as those of the operation input unit 310, the screen display unit 320, and the communication I/F unit 330 described in the first exemplary embodiment. Therefore, the detailed description is omitted.

The storage unit 640 is a storage device such as a hard disk or a memory. The storage unit 640 stores therein processing information and a program 643 required for various types of processing performed in the arithmetic processing unit 650. The program 643 is read and executed by the arithmetic processing unit 350 to thereby implement various processing units. The program 643 is read in advance from an external device or a storage medium via a data input/output function of the communication I/F unit 630 or the like, and is stored in the storage unit 640. The main information stored in the storage unit 640 includes prior information 641, structure information 642, and the like.

The prior information 641 includes information that is previously known about the training data having been used for training of the decision tree 511 stored in the model storage device 500, as similar to the prior information 341 described in the first exemplary embodiment. For example, the prior information 641 may include information in which partial training data information and unknown feature information are associated with each other. For example, the prior information 641 is acquired in advance by using a method of acquiring it from an external device via the communication OF unit 630 or inputting it using the operation input unit 610, and is stored in the storage unit 640.

The structure information 642 includes information showing structure data of the decision tree 511 that is acquired from the model storage device 500 by a structure information receiving unit 651. For example, the structure information 642 is generated and updated corresponding to acquisition of the structure data by the structure information receiving unit 651, to be described below, from the model storage device 500.

The arithmetic processing unit 650 includes an arithmetic unit such as a CPU and its peripheral circuits. The arithmetic processing unit 650 reads, from the storage unit 640, and executes the program 643 to implement various processing units through cooperation between the hardware and the program 643. Main processing units to be implemented by the arithmetic processing unit 650 include, for example, the structure information receiving unit 651, the specifying unit 652, the assessment unit 653, and the output unit 654. Note that the arithmetic processing unit 650 may include a GPU or the like in place of the CPU, as described above.

The structure information receiving unit 651 acquires structure data such as a structure of the decision tree 511 and branch conditions, from the model storage device 500. The structure information receiving unit 651 may transmit an instruction requesting transmission of structure data to the model storage device 500 at any timing, and acquire structure data transmitted in response to the instruction from the model storage device 500. Further, the structure information receiving unit 651 stores the acquired structure data in the storage unit 640 as the structure information 642.

The specifying unit 652 specifies a possible range that the unknown feature may take, on the basis of the structure data that is score information. For example, the specifying unit 652 specifies a possible range that the unknown feature may take by excluding, among the candidates (v₁ₗ, . . . , v₁ₖ) of the unknown feature x₁, a candidate value determined that there is no possibility that the candidate has constituted the training data actually or the possibility is low, on the basis of the structure data.

For example, the specifying unit 652 refers to the structure data and specifies a leaf node corresponding to the score value including a value that is equal to or smaller than a given threshold. Further, the specifying unit 652 checks the branch condition of each node existing on the route between the specified leaf node and the root node in the decision tree 511. For example, the specifying unit 652 checks whether or not there is a node in which branch is made by the unknown feature on the route between the specified leaf node and the root node. Then, when there is a node in which branch is made by the unknown feature, the specifying unit 652 excludes a candidate value that is a combination of feature values including a value of the unknown feature, satisfying the branch condition of each node existing on the route.

Specifically, for example, referring to FIG. 14, a score value of a leaf node is [0, aa, bb], which includes a value 0 that is equal to or smaller than a given threshold. Accordingly, the specifying unit 652 checks the branch condition of each node existing on the route between the leaf node and the root node, as illustrated in FIG. 14. In the case of FIG. 14, a node in which branch is made by the unknown feature is included on the checked route. Therefore, the specifying unit 652 excludes a candidate value that is a combination of feature values including the value of the unknown feature, satisfying the branch condition of each node existing on the route, from the candidates.

For example, as described above, the specifying unit 652 checks whether or not there is a node in which branch is made by the unknown feature on the route between a leaf node satisfying a given condition and the root node, and performs exclusion based on the branch condition of each node according to the checked result. By performing such determination for each leaf node satisfying the condition, the specifying unit 652 can specify a possible range that the unknown feature may take, based on the structure data. Note that the threshold may be set arbitrarily.

Note that the specifying unit 652 may perform processing similar to that performed by the specifying unit 354 described in the first exemplary embodiment based on the structure data, and exclude a candidate value of the unknown feature.

The assessment unit 653 can perform risk assessment of privacy leakage or the like, based on the result specified by the specifying unit 652. For example, as similar to the assessment unit 355 described in the first exemplary embodiment, the assessment unit 653 may perform risk assessment corresponding to the number or pieces of candidate data excluded by the specifying unit 652.

The output unit 654 outputs information according to a result specified by the specifying unit 652, information representing the assessment result by the assessment unit 653, and the like. For example, the output unit 654 displays such information on the screen display unit 620, or transmits it to an external device via the communication OF unit 630.

The exemplary configuration of the risk assessment device 600 is as described above. Note that the risk assessment device 600 may have a configuration similar to that of the risk assessment device 300 described in the first exemplary embodiment in addition to the configuration described above, or may adopt various modifications held by the risk assessment device 300 described in the first exemplary embodiment. For example, the risk assessment device 600 may have a function similar to that of the instruction unit 357 described in the first exemplary embodiment. Next, an exemplary operation of the risk assessment device 600 will be described with reference to FIG. 15.

Referring to FIG. 15, the structure information receiving unit 651 acquires structure data such as a structure of the decision tree 511, branch conditions, and a score value from the model storage device 500 (step S301).

The specifying unit 652 specifies a possible range that the unknown feature may take, based on the structure data that is score information (step S302). For example, the specifying unit 652 specifies a possible range that the unknown feature may take by excluding, among the candidates (v₁ₗ, . . . , v₁ₖ) of the unknown feature x₁, a candidate value determined that there is no possibility that the candidate has constituted the training data actually or the possibility is low, based on the structure data. For example, the specifying unit 652 can specify a possible range that the unknown feature may take by checking whether or not there is a node in which branch is made by the unknown feature on the route between a leaf node satisfying a given condition and the root node, and performing exclusion based on the branch condition of each node according to the checked result.

The assessment unit 653 performs risk assessment of privacy leakage or the like, based on the result specified by the specifying unit 652 (step S303). For example, the assessment unit 653 performs risk assessment corresponding to the number of pieces of candidate data excluded by the specifying unit 652.

The exemplary operation of the risk assessment device 600 is as described above.

As described above, the risk assessment device 600 includes the structure information receiving unit 651 and the specifying unit 652. With such a configuration, the specifying unit 652 can specify a possible range that the unknown feature may take, by excluding a candidate value satisfying the condition from the candidates based on the structure data acquired by the structure information receiving unit 651. As a result, it is possible to determine the risk according to a specific result. That is, according to the above-described configuration, it is possible to perform risk assessment appropriately even in a situation where the value of the unknown feature can be specified, for example.

### Third Exemplary Embodiment

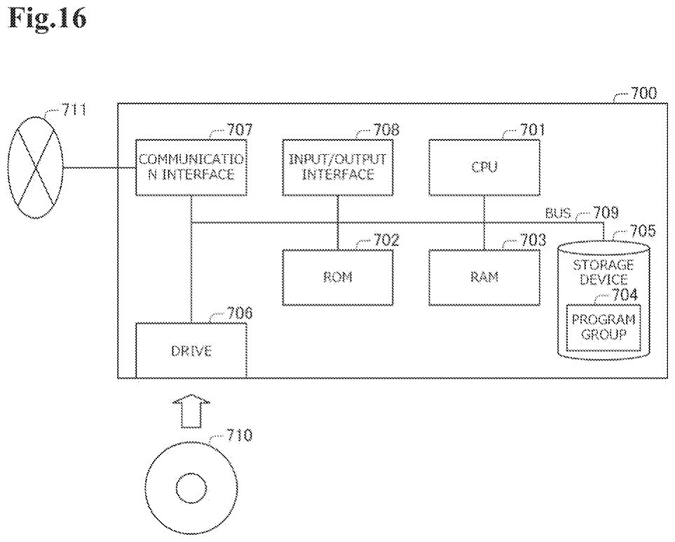

A third exemplary embodiment of the present disclosure describes an exemplary configuration of a processing device 700 that is an information processing device capable of performing a specifying process for assessment to specify a possible range that a value of an unknown feature may take, based on information of known features and the like. FIG. 16 illustrates an exemplary hardware configuration of the processing device 700. Referring to FIG. 16, the processing device 700 has a hardware configuration as described below, as an example.
Central Processing Unit (CPU) 701 (arithmetic unit)
Read Only Memory (ROM) 702 (storage device)
Random Access Memory (RAM) 703 (storage device)
Program group 704 to be loaded to the RAM 703
Storage device 705 storing therein the program group 704
Drive 706 that performs reading and writing on a storage medium 710 outside the information processing device
Communication interface 707 connecting to a communication network 711 outside the information processing device
Input/output interface 708 for performing input/output of data
Bus 709 connecting the respective constituent elements

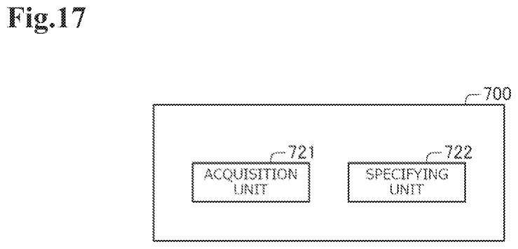

Further, the processing device 700 can realize functions as the acquisition unit 721 and the specifying unit 722 illustrated in FIG. 17 through acquisition and execution of the program group 704 by the CPU 701. Note that the program group 704 is stored in the storage device 705 or the ROM 702 in advance for example, and is loaded to the RAM 703 by the CPU 701 as needed. Further, the program group 704 may be provided to the CPU 701 via the communication network 711, or may be stored on a storage medium 710 in advance and read out by the drive 706 and supplied to the CPU 701.

FIG. 16 illustrates an exemplary hardware configuration of the processing device 700. The hardware configuration of the processing device 700 is not limited to that described above. For example, the processing device 700 may be configured of part of the configuration described above, such as without the drive 706.

The acquisition unit 721 acquires, from a decision tree that is a learned model and consists of a plurality of nodes, score information representing a value corresponding to the number of pieces of data that fell to a node among a plurality of pieces of training data having been used for training of the decision tree.

The specifying unit 722 specifies a possible range that a value of an unknown feature, that is part of a plurality of features included in the training data, may take, on the basis of the score information acquired by the acquisition unit 721.

As described above, the processing device 700 includes the acquisition unit 721 and the specifying unit 722. With such a configuration, the specifying unit 722 can specify a possible range that an unknown feature, that is a part of a plurality of features included in the training data, may take, based on the score information acquired by the acquisition unit 721. As a result, it is possible to determine the risk according to the specified result. That is, according to the above-described configuration, it is possible to perform risk assessment appropriately even in a situation where the value of the unknown feature can be specified, for example.

Note that the processing device 700 as described above can be realized by incorporation of a predetermined program in the information processing device such as the processing device 700. Specifically, a program that is another aspect of the present invention is a program for realizing processing in the information processing device such as the processing device 700 to acquire score information from a decision tree that is a learned model and consists of a plurality of nodes, the score information representing a value corresponding to the number of pieces of data that fell to each node among a plurality of pieces of training data having been used for training of the decision tree, and based on the acquired score information, specify a possible range that the value of an unknown feature that is a part of features included in the training data, may take.

Further, a processing method implemented by an information processing device such as the processing device 700 is a method of, by an information processing device such as the processing device 700, acquiring score information from a decision tree that is a learned model and consists of a plurality of nodes, the score information representing a value corresponding to the number of pieces of data that fell to each node among a plurality of pieces of training data having been used for training of the decision tree, and based on the acquired score information, specifying a range that a value of an unknown feature that is a part of the features included in the training data, may take.

An invention of a program, a computer-readable storage medium storing a program, or a processing method having the above-described configuration also exhibits the same actions and effects as those of the processing device 700. Therefore, the above-described object of the present invention can also be achieved by such an invention.

<Supplementary Notes>

The whole or part of the exemplary embodiments disclosed above can be described as the following supplementary notes. Hereinafter, the outlines of the processing device and the like of the present invention will be described. However, the present invention is not limited to the configurations described below.

### (Supplementary Note 1)

A processing device, comprising:
an acquisition unit that acquires, from a decision tree that is a learned model and includes a plurality of nodes, score information representing a value according to the number of pieces of data that fell to each of the nodes, among a plurality of pieces of training data used for training of the decision tree; and
a specifying unit that, on the basis of the score information acquired by the acquisition unit, specifying a possible range that a value of an unknown feature may take, the unknown feature being a part of a plurality of features included in the training data.

### (Supplementary Note 2)

The processing device according to supplementary note 1, further comprising
a creation unit that creates a plurality of pieces of candidate data on the basis of information representing a value of a known feature having been held and information representing a candidate value of the unknown feature, wherein
the acquisition unit acquires the score information by acquiring a plurality of inference results that are inferred as a result of inputting the plurality of pieces of created candidate data to the decision tree, respectively.

### (Supplementary Note 3)

The processing device according to supplementary note 2, wherein
the training data includes a plurality of feature values and labels,
the inference result represents a value according to a ratio of the number of pieces of data corresponding to each of the labels to the training data, on a leaf node to which candidate data belongs among the nodes included in the decision tree, and
the specifying unit specifies the possible range that the value of the unknown feature may take by excluding the candidate value on the basis of a value according to a label corresponding to the candidate data in the inference result.

### (Supplementary Note 4)

The processing device according to supplementary note 3, wherein
the specifying unit specifies the possible range that the value of the unknown feature may take by excluding the candidate value in which the value according to the label corresponding to the candidate data in the inference result becomes equal to or smaller than a given threshold.

### (Supplementary Note 5)

The processing device according to supplementary note 1, wherein
the acquisition unit acquires the score information by acquiring structure information of the decision tree corresponding to each of the nodes included in the decision tree,
the score information represents a value corresponding to a ratio of the number of pieces of data corresponding to each label to the training data, on the node, and
the specifying unit specifies a leaf node corresponding to the score information including a value that becomes equal to or smaller than a given threshold, and specifies the possible range that the value of the unknown feature may take on a basis of the score information corresponding to the node existing on a route between the specified leaf node and a root node that is a first branch in the decision tree.

### (Supplementary Note 6)

The processing device according to supplementary note 5, wherein
the specifying unit specifies the possible range that the value of the unknown feature may take by checking whether or not there is a node serving as a branch by the unknown feature among the nodes existing on the route between the leaf node and the root node.

### (Supplementary Note 7)

The processing device according to supplementary note 1, further comprising
an instruction unit that instructs how to output the score information by the decision tree on the basis of a specifying result by the specifying unit.

### (Supplementary Note 8)

The processing device according to supplementary note 1, further comprising
an assessment unit that performs risk assessment of the decision tree on the basis of a specifying result by the specifying unit.

### (Supplementary Note 9)

A processing method comprising, by an information processing device:
acquiring, from a decision tree that is a learned model and includes a plurality of nodes, score information representing a value according to the number of pieces of data that fell to each of the nodes, among a plurality of pieces of training data used for training of the decision tree; and
on the basis of the acquired score information, specifying a possible range that a value of an unknown feature may take, the unknown feature being a part of a plurality of features included in the training data.

### (Supplementary Note 10)

A program for causing an information processing device to execute processing to:
acquire, from a decision tree that is a learned model and includes a plurality of nodes, score information representing a value according to the number of pieces of data that fell to each of the nodes, among a plurality of pieces of training data used for training of the decision tree; and
on the basis of the acquired score information, specify a possible range that a value of an unknown feature may take, the unknown feature being a part of a plurality of features included in the training data.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

100 risk assessment system
200 model storage device
210 receiving unit
220 inference unit
230 output unit
240 storage unit
241 decision tree
300 risk assessment device
310 operation input unit
320 screen display unit
330 communication IN unit
340 storage unit
341 prior information
342 inference result information
343 program
350 arithmetic processing unit
351 candidate data creation unit
352 candidate data transmission unit
353 inference result acquisition unit
354 specifying unit
355 assessment unit
356 output unit
357 instruction unit
400 risk assessment system
500 model storage device
510 storage unit
511 decision tree
520 structure information transmission unit
600 risk assessment device
610 operation input unit
620 screen display unit
630 communication IN unit
640 storage unit
641 prior information
642 structure information
643 program
650 arithmetic processing unit
651 structure information receiving unit
652 specifying unit
653 assessment unit
654 output unit
700 processing device
701 CPU
702 ROM
703 RAM
704 program group
705 storage device
706 drive
707 communication interface
708 input/output interface
709 bus
710 storage medium
711 communication network
721 acquisition unit
722 specifying unit

1. A processing device, comprising:
a memory containing program instructions; and
a processor connected to the memory, wherein the processor is configured to execute the program instructions to:
acquire, from a decision tree that is a learned model and includes a plurality of nodes, score information representing a value according to a number of pieces of data that fell to each of the nodes, among a plurality of pieces of training data used for training of the decision tree; and
on a basis of the acquired score information, specifying a possible range that a value of an unknown feature takes, the unknown feature being a part of a plurality of features included in the training data.

2. The processing device according to claim 1, wherein the processor is configured to execute the program instructions to:
create a plurality of pieces of candidate data on a basis of information representing a value of a known feature having been held and information representing a candidate value of the unknown feature; and
acquire the score information by acquiring a plurality of inference results that are inferred as a result of inputting the plurality of pieces of created candidate data to the decision tree, respectively.

3. The processing device according to claim 2, wherein
the training data includes a plurality of feature values and labels,
the inference result represents a value according to a ratio of a number of pieces of data corresponding to each of the labels to the training data, on a leaf node to which candidate data belongs among the nodes included in the decision tree, and
the processor is configured to execute the program instructions to specify the possible range that the value of the unknown feature takes by excluding the candidate value on a basis of a value according to a label corresponding to the candidate data in the inference result.

4. The processing device according to claim 3, wherein the processor is configured to execute the program instructions to
specify the possible range that the value of the unknown feature takes by excluding the candidate value in which the value according to the label corresponding to the candidate data in the inference result becomes equal to or smaller than a given threshold.

5. The processing device according to claim 1, wherein the processor is configured to execute the program instructions to:
acquire the score information by acquiring structure information of the decision tree corresponding to each of the nodes included in the decision tree,
the score information representing a value corresponding to a ratio of a number of pieces of data corresponding to each label to the training data, on the node; and
specify a leaf node corresponding to the score information including a value that becomes equal to or smaller than a given threshold, and specify the possible range that the value of the unknown feature takes on a basis of the score information corresponding to the node existing on a route between the specified leaf node and a root node that is a first branch in the decision tree.

6. The processing device according to claim 5, wherein the processor is configured to execute the program instructions to
specify the possible range that the value of the unknown feature takes by checking whether or not there is a node serving as a branch by the unknown feature among the nodes existing on the route between the leaf node and the root node.

7. The processing device according to claim 1, wherein the processor is configured to execute the program instructions to
instruct how to output the score information by the decision tree on a basis of a result of specifying.

8. The processing device according to claim 1, wherein the processor is configured to execute the program instructions to
perform risk assessment of the decision tree on a basis of a result of specifying.

9. A processing method comprising, by an information procesing device:
acquiring, from a decision tree that is a learned model and includes a plurality of nodes, score information representing a value according to a number of pieces of data that fell to each of the nodes, among a plurality of pieces of training data used for training of the decision tree; and
on a basis of the acquired score information, specifying a possible range that a value of an unknown feature takes, the unknown feature being a part of a plurality of features included in the training data.

10. A non-transitory computer-readable medium storing thereon a program comprising instructions for causing an information processing device to execute processing to:
acquire, from a decision tree that is a learned model and includes a plurality of nodes, score information representing a value according to a number of pieces of data that fell to each of the nodes, among a plurality of pieces of training data used for training of the decision tree; and
on a basis of the acquired score information, specify a possible range that a value of an unknown feature takes, the unknown feature being a part of a plurality of features included in the training data.
